(19) United States
(12) Patent Application Publication
(10) Pub. No.: US 2020/0079304 A1
(43) Pub. Date: Mar. 12, 2020

(54) GROMMET

(71) Applicants: YAZAKI CORPORATION, Tokyo (JP); TOYOTA JIDOSHA KABUSHIKI KAISHA, Toyota-shi (JP)

(72) Inventors: Katsuya Yoshimura, Toyota-shi (JP); Ryohei Toyoda, Toyota-shi (JP); Yasunori Hattori, Toyota-shi (JP); Tomoyoshi Katayama, Miyoshi-shi (JP); Akinori Ishikawa, Toyota-shi (JP)

(73) Assignees: YAZAKI CORPORATION, Tokyo (JP); TOYOTA JIDOSHA KABUSHIKI KAISHA, Toyota-shi (JP)

(21) Appl. No.: 16/564,313

(22) Filed: Sep. 9, 2019

(30) Foreign Application Priority Data
Sep. 10, 2018 (JP) 2018-168717

(51) Int. Cl. B60R 16/02; H02G 3/22

(52) U.S. Cl. CPC B60R 16/0222; H02G 3/0468; H02G 3/22

(57) ABSTRACT

A grommet includes a lip mountain integrated with an inner side harness insertion portion; a panel abutment portion abutting on a periphery of the through hole on an outer side of a vehicle body panel; a connection portion connecting the lip mountain and the panel abutment portion; a work unit formed across an outer side harness insertion portion and the panel abutment portion; and a work pressing portion integrated with the outer side harness insertion portion and the work unit. The connection portion includes an inclined portion that is gradually reduced in diameter toward the panel abutment portion; a parallel portion that is connected to the inclined portion and has a constant outer diameter; and a projection portion that is formed in the parallel portion and projects outward. The lip mountain and the inclined portion are smoothly connected by a mountain-shaped portion having a substantially arc shape in cross section.

### CROSS-REFERENCE TO RELATED APPLICATIONS

This application is based on and claims priority under 35 USC 119 from Japanese Patent Application No. 2018-168717 filed on Sep. 10, 2018, the contents of which are incorporated herein by reference.

### TECHNICAL FIELD

The present invention relates to a grommet, and particularly relates to a grommet mounted to a through hole for protecting a wire harness that penetrates the through hole formed in a plate material.

### BACKGROUND ART

In related art, a grommet is in a watertight manner fitted into a through hole formed in a vehicle body panel of a vehicle such as an automobile, and a wire harness is inserted into the grommet in the watertight manner and irremovable manner.

The grommet includes an inner side harness insertion portion and an outer side harness insertion portion, into which the wire harness is inserted; a substantially truncated-cone-shaped (so-called bowl-like) inner side wall that is integrated with the inner side harness insertion portion at a small diameter side end and is increased in diameter toward an outer side; a substantially truncated-cone-shaped (so-called bowl-like) outer side wall that is integrated with the outer side harness insertion portion at a small diameter side end and is increased in diameter toward an inner side; a connection portion that connects a large diameter side of the inner side wall and a large diameter side of the outer side wall. A fitting portion that is fitted into the through hole is formed in the connection portion.

The fitting portion includes an inner side lip that is formed on the inner side wall and abuts on an inner side surface of the vehicle body panel; an outer side lip that is formed on the outer side wall and abuts on an outer side surface of the vehicle body panel; and the fitting portion that is located inward than the inner side lip and the outer side lip and provided with a projection formed in the connection portion (for example, see Patent Literature 1).

### CITATION LIST

### Patent Literature

Patent Literature 1: JP-A-2017-220976 (Pages 6 to 7, FIG. 3)

### SUMMARY OF INVENTION

The grommet disclosed in Patent Literature 1 is mounted to the through hole formed in the vehicle body panel by pushing the grommet from the outer side toward the inner side. The inner side lip is continuously formed at a maximum outer diameter position of the inner side wall and projects toward the outer side. That is, an inclined surface is formed between the inner side lip and the connection portion so as to enter into the inner side, and the inner side lip includes an overhanging “return portion”.

Therefore, when the grommet is pushed from the outer side toward the inner side, a semi-fitting state may be caused, resulting in low water sealing property. That is, the inner side wall slides on an inner circumference of the through hole, and the inner side lip is pushed down toward the inner side and moves to the inner side. Then, when the outer side lip abuts on the outer side surface of the vehicle body panel, the inner side lip cannot abut on the inner side surface of the vehicle body panel in a state of being caught by the through hole. Therefore, the connection portion “does not enter” into the through hole, and the projection formed in the connection portion does not abut on the inner circumference of the through hole.

The present invention is to solve the above problems, and to provide a grommet that is mounted by being pushed toward the inner side and has high water sealing property.

A grommet according to the present invention is a grommet mounted in a through hole formed in a vehicle body panel, and includes an inner side harness insertion portion that extends toward a vehicle inner side and through which a wire harness penetrates; an outer side harness insertion portion that extends toward a vehicle outer side and through which a wire harness penetrates; a lip mountain integrated with the inner side harness insertion portion; a panel abutment portion that abuts on a periphery of the through hole on an outer side of the vehicle body panel; a connection portion that connects the lip mountain and the panel abutment portion; a work unit formed across the outer side harness insertion portion and the panel abutment portion; and a work pressing portion integrated with the outer side harness insertion portion and the work unit. The connection portion includes an inclined portion that is gradually reduced in diameter toward the panel abutment portion; a parallel portion that is connected to the inclined portion and has a constant outer diameter; and a projection portion that is formed in the parallel portion and projects outward. The lip mountain and the inclined portion are smoothly connected by a mountain-shaped portion having a substantially arc shape in cross section.

In addition, a flange is formed around the through hole. When the grommet is mounted to the through hole, the mountain-shaped portion slides on the flange and bends inward. In a state that the grommet is mounted in the through hole, the inclined portion and the projection portion are in close contact with the flange.

In the grommet according to the present invention, when the work unit is pushed toward the inner side, the lip mountain slides in the through hole and is reduced in diameter, and the mountain-shaped portion bends inward and passes through the through hole. After further passing, the inclined portion abuts on the through hole. Thereby, the water sealing property is ensured. Further, since the inclined portion and the projection portion are in close contact with the flange formed around the through hole, the reliable water sealing property can be obtained.

### BRIEF DESCRIPTION OF DRAWINGS

FIG. 1 is a perspective view schematically illustrating a structure of a grommet according to a first embodiment of the present invention, as obliquely viewed from a front side.

FIG. 2 is a perspective view schematically illustrating the structure of the grommet according to the first embodiment of the present invention, as obliquely viewed from a rear side.

FIG. 3 is a cross-sectional side view schematically illustrating the structure of the grommet according to the first embodiment of the present invention.

FIG. 4 is a cross-sectional side view schematically illustrating the structure of the grommet according to the first embodiment of the present invention.

FIG. 5 is a cross-sectional side view schematically showing a structure of an enlarged part (a connection portion) of the grommet according to the first embodiment of the present invention.

FIG. 6 is a cross-sectional side view schematically showing grommet mounting procedure according to the first embodiment of the present invention, in which a lower side of a central axis 1 shows a beginning of mounting, and an upper side of the central axis 1 shows the mounting in progress.

FIG. 7 is a cross-sectional side view schematically illustrating a fitting form of the grommet according to the first embodiment of the present invention.

FIG. 8 schematically illustrates differences between the fitting form of the grommet according to the first embodiment of the present invention and a fitting form according to the related art, and is a cross-sectional view showing a part in a state of being mounted by being pulled toward an inner side in the related art.

FIG. 9 schematically illustrates differences between the fitting form of the grommet according to the first embodiment of the present invention and a fitting form according to related art, and is a cross-sectional view showing a part in a state of being mounted by being pushed from an outer side in the related art.

### DESCRIPTION OF EMBODIMENTS

Hereinafter, a grommet according to a first embodiment of the present invention will be described with reference to the drawings. Since the drawings are for schematic illustration, shape and size of each member, or positional relationship between members is not limited to the illustrated embodiment. In order to avoid complication of the drawings, some of the signs may be omitted.

### First Embodiment

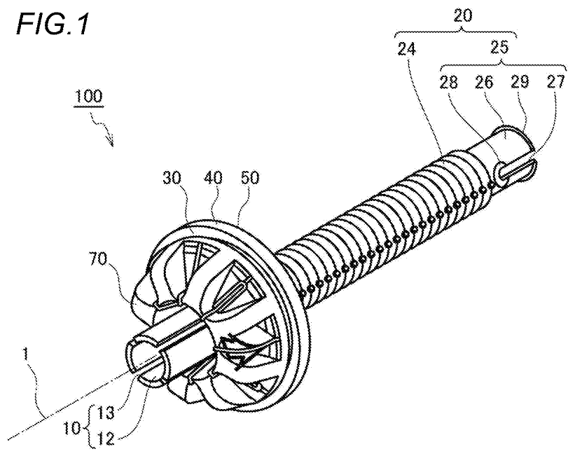

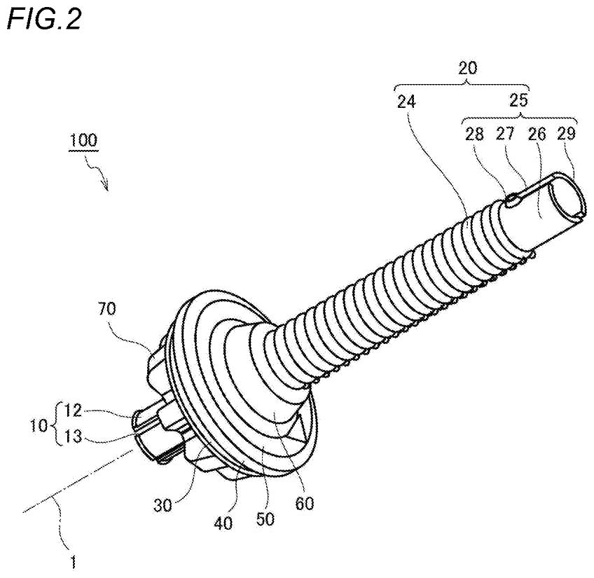

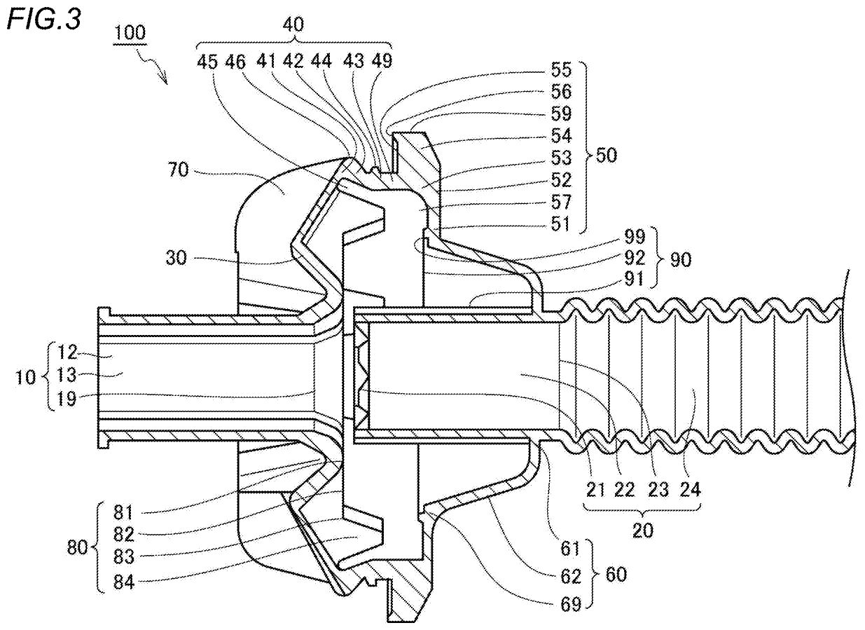

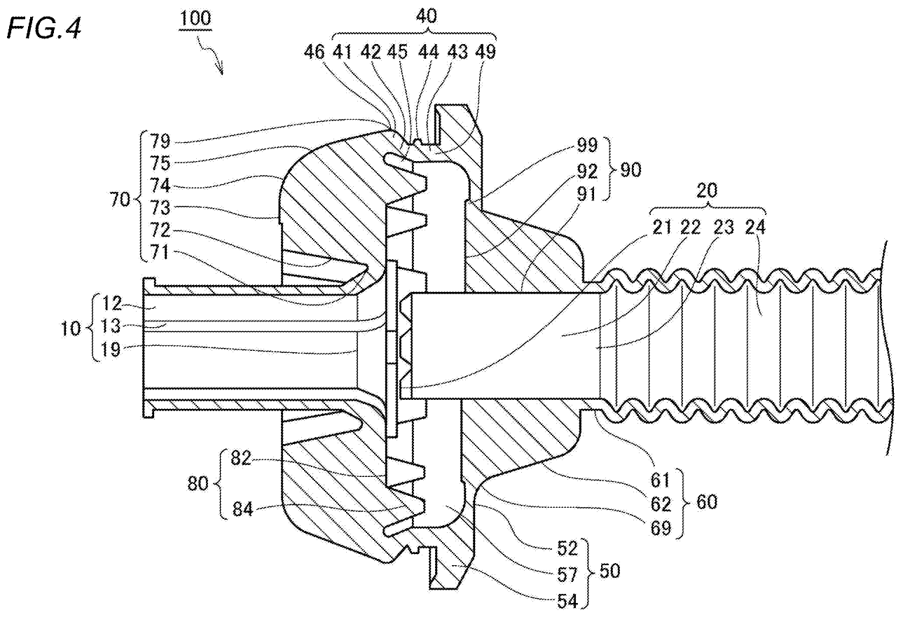

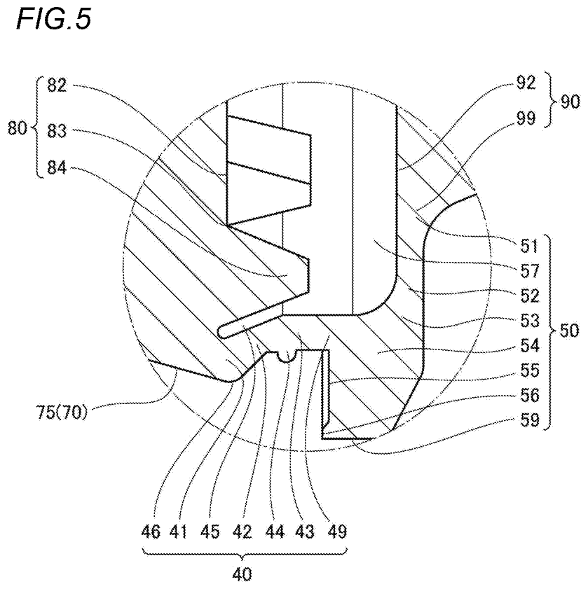

FIGS. 1 to 5 schematically show a structure of the grommet according to the first embodiment of the present invention. FIG. 1 is a perspective view as obliquely viewed from a front side, FIG. 2 is a perspective view as obliquely viewed from a rear side, FIG. 3 is a cross-sectional side view, FIG. 4 is a cross-sectional side view, and FIG. 5 is a cross-sectional side view showing an enlarged part (a connection portion).

### (Overall Configuration)

In FIGS. 1 and 2, a grommet 100 is provided for protecting a wire harness (not shown) that penetrates a through hole formed in a vehicle body panel of a vehicle such as an automobile. Hereinafter, a case where the grommet 100 is pushed into a through hole 8 from a vehicle exterior side (a rear side) toward a vehicle interior side (a front side) will be described. The present invention is not limited to be mounted to the through hole 8 formed in a vehicle body panel 9, and is also mounted to through holes formed in various structures and various devices.

### (Indoor Side Harness Insertion Portion and Outer Side Harness Insertion Portion)

FIGS. 1 and 2, an inner side harness insertion portion 10 (corresponding to a first harness insertion portion in claim) includes arc pieces 12 having an arc shape in cross section, and axially parallel insertion portion slits 13 are formed between side edges of the arc pieces 12. A lip mountain base 30 is integrated with a rear end 19 (see FIG. 3) of the inner side harness insertion portion 10.

Further, an outer side harness insertion portion 20 (corresponding to a second harness insertion portion in claim) includes a slit-free cylindrical portion 22 between a front end 21 and an intermediate position 23 (see FIG. 3), a corrugated portion 24 connected to the cylindrical portion 22, and a slit portion 25 connected to the corrugated portion 24. A pair of through holes 28 is formed in the slit portion 25, and axially parallel slits 27 are formed between the through holes 28 and a rear end 29. That is, arc pieces 26 having a semicircular cross section are formed so as to be sandwiched by the slits 27.

Since a central axis of the inner side harness insertion portion 10 and a central axis of the outer side harness insertion portion 20 are identical, those axes are hereinafter referred to as a “central axis 1”, a direction toward or a position near the central axis 1 is referred to as “inward” or “inner”, and a direction or a position away from the central axis 1 is referred to as “outward” or “outer”. In addition, a side of the inner side harness insertion portion 10 is referred to as an “inner side (first side)”, and a side of the outer side harness insertion portion 20 is referred to as an “outer side (second side)”. Incidentally, “integrated” may be referred to a case where separated portions are integrally molded in a continuous state, and a case where separate portions are separately formed and then connected to each other, and hereinafter, may be referred to as “connected” or the like.

Hereinafter, each of portions will be described in detail with reference to FIGS. 3 to 5.

### (Lip Mountain)

Lip mountains 70 each have a substantially rectangular shape in a front view, project toward an inner side of the lip mountain base 30, and are equiangularly arranged at eight circumferential positions on the lip base 30, thereby mainly enhancing rigidity of the lip mountain base 30.

The lip mountains 70 are connected to the lip mountain base 30 at a lip mountain inner circumference 71 in a side view, and each include a lip mountain inner surface 72 that gradually extends outward toward the inner side, and a lip mountain inner side surface 73 that is continuous with the lip mountain inner surface 72 and perpendicular to the central axis 1, and a lip mountain arc surface 74 that connects the lip mountain inner side surface 73 and a lip mountain outer surface 75. The lip mountain outer surface 75 shows a substantially straight line that is gradually increased in diameter (outward) toward the outer side (a connection portion 40).

### (Intermediate Rib)

Intermediate ribs 80 are equiangularly arranged at eight circumferential positions on an outer side of the lip mountain base 30. At this time, the lip mountains 70 and the intermediate ribs 80 have the same circumferential phases. The intermediate ribs 80 each include an inner circumference 81, an outer side surface 82, and a projection portion 84 that is outward than an intermediate position 83 and projects to the outer side in the side view. Projection portions 84 mainly enhance the rigidity of the lip mountain base 30. Installation of the intermediate ribs 80 may be omitted.

### (Panel Abutment Portion)

The panel abutment portion 50 is integrated with an outer circumference 69 of a work unit 60 at an inner circumference 51 in the side view, and includes a thin portion 52 perpendicular to the central axis 1, and a thick portion 54 integrated with an outer circumference (hereinafter referred to as an “intermediate position 53”) of the thin portion 52. The thick portion 54 projects toward the inner side more than the thin portion 52 and includes a panel abutment surface 55 perpendicular to the central axis 1. An annular panel abutment projection 56 projecting toward the inner side is formed in an outer circumference 59 of the panel abutment surface 55 (accurately, in a predetermined width range close to the outer circumference 59).

A space 57 is formed by the lip mountains 70, the connection portion 40, and the panel abutment portion 50 (or the work unit 60).

### (Work Unit and Work Pressing Portion)

The work unit 60 has a substantially bell shape, an inner circumference 61 is connected to the intermediate position 23 of the outer side harness insertion portion 20, and the outer circumference 69 is integrally connected to the inner circumference 51 of the panel abutment portion 50. A side surface 62 gradually approaches inward toward the outer side. The outer circumference 69 and the inner circumference 51 are virtual surfaces defined for convenience of description, and positions thereof are not strictly specified (other joints are described such that virtual surfaces are joined to each other).

A plurality of work pressing portions 90 are integrated across the side surface 62 of the work unit 60 and the cylindrical portion 22 of the outer side harness insertion portion 20. The work pressing portions 90 are radially arranged plate-shaped bodies, and each include an inner circumference 91 connected to the cylindrical portion 22 of the outer side harness insertion portion 20, an outer circumference 99 integrated with the outer circumference 69 of the work unit 60, and an inner side surface 92 perpendicular to the central axis 1. The inner side surface 92 is located in a pane substantially the same as the thin portion 52 of the panel abutment portion 50, but may project toward the lip mountains 70.

### (Connection Portion)

In FIG. 5, the connection portion 40 connects the lip mountains 70 and the panel abutment portion 50. That is, in the connection portion 40, a front surface 41 is connected to the lip mountain base 30, and a rear surface 49 is connected to the panel abutment portion 50 (in a range close to the intermediate position 53).

The connection portion 40 is a thin-walled cylinder, and includes an inclined portion 42 inclined so as to be gradually inward toward the outer side, and a parallel portion 43 connected to the inclined portion 42 and parallel to the central axis 1. A projection portion 44 projecting from an outer surface of the parallel portion 43 is formed. A gap 45 is formed between the inclined portion 42 and the projection portion 84 of each intermediate rib 80.

The lip mountain outer surface 75 and the inclined portion 42 are smoothly connected by a mountain-shaped portion 46 having a substantially arc shape in cross section. At this time, the mountain-shaped portion 46 has a predetermined rigidity.

The front surface 41, the rear surface 49 and the like are virtual surfaces defined for convenience of description indicating integrally connected positions, and the positions thereof are not strictly specified. In addition, a shape of the projection portion 44 is not limited to be semicircular in cross section as illustrated, and may be rectangular in cross section or trapezoidal in cross section.

### (Mounting Procedure)

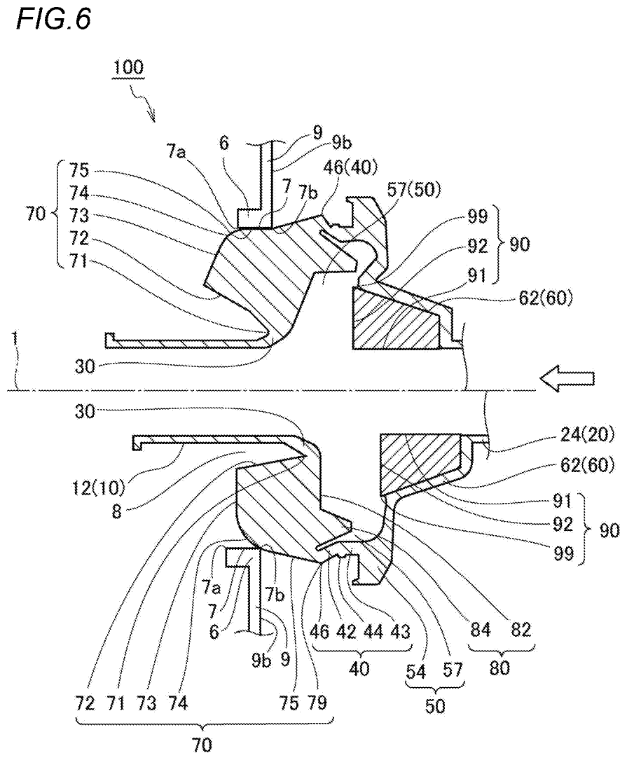

FIG. 6 is a cross-sectional side view schematically showing grommet mounting procedure according to the first embodiment of the present invention, in which a lower side of a central axis 1 shows a beginning of mounting, and an upper side of the central axis 1 shows the mounting in progress.

At the beginning of the mounting shown below the central axis 1 in FIG. 6, the lip mountain 70 is pushed into the through hole 8. A flange 6 is provided in the through hole 8, and an inner side end of the flange 6 is referred to as a “through hole front end 7a” and an outer side end of the flange 6 is referred to as a “through hole rear end 7b” for convenience of description. That is, the lip mountain arc surface 74 of the lip mountain 70 abuts on the through hole rear end 7b.

During the mounting shown on the upper side of the central axis 1 in FIG. 6, the lip mountain 70 is further pushed into the through hole 8. Therefore, the lip mountain arc surface 74 is reduced in diameter by moving to the inner side while sliding on a through hole inner circumference 7, and the mountain-shaped portion 46 subsequently bends inward and slides on the through hole inner circumference 7.

Therefore, when further pushed, the mountain-shaped portion 46 separates from the through hole inner circumference 7 and passes over the through hole front end 7a, so that the inclined portion 42 abuts so as to bite the through hole front end 7a, and the connection portion 40 is fitted into the through hole inner circumference 7. The projection portion 44 is in close contact with the through hole inner circumference 7, and at the same time, the panel abutment projection 56 of the panel abutment portion 50 is in close contact with an outer side surface of the vehicle body panel 9 (hereinafter referred to as a “panel outer side surface 9b”) (This will be described in detail below).

### (Fitting Form)

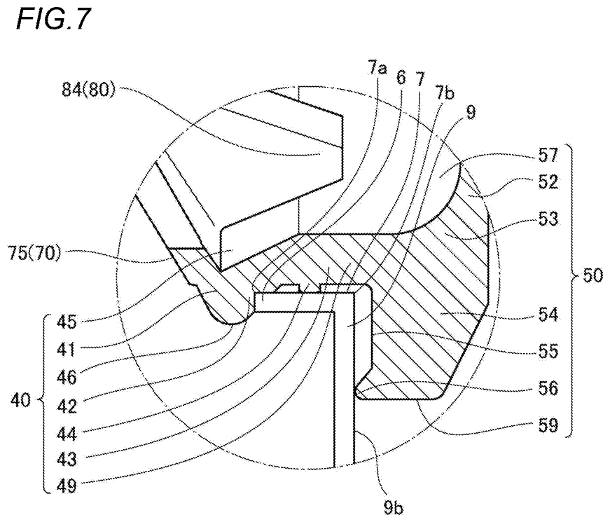

FIG. 7 is a cross-sectional side view schematically illustrating a fitting form of the grommet according to the first embodiment of the present invention.

In FIG. 7, the connection portion 40 is fitted into the through hole 8 (see FIG. 6). At this time, pushing is finished, and the lip mountains 70 (the lip mountain base 30) are elastically restored. That is, while the mountain-shaped portion 46 slides on the through hole inner circumference 7, the outer circumference 79 of the lip mountain 70 is reduced in diameter, but when the mountain-shaped portion 46 passes over the through hole front end 7a, the mountain-shaped portion 46 is elastically restored and increased in diameter. Then, the through hole front end 7a abuts so as to bite the inclined portion 42. The through hole inner circumference 7 is pressed against the projection portion 44 and the panel outer side surface 9b is pressed against the panel abutment projection 56.

Since the grommet 100 is an elastic body, the projection portion 44 is elastically deformed. For this reason, the most projecting position of the projection portion 44 is linear before the mounting, and is in a planar range of a predetermined width after the mounting.

### (Function and Effects)

As described above, the grommet 100 includes the mountain-shaped portion 46 that smoothly connects the lip portion outer surface 75 and the inclined portion 42, and since the mountain-shaped portion 46 supports the inclined portion 42 with the predetermined rigidity, the through hole front end 7a abuts so as to strongly bite the inclined portion 42. In addition, since the flange 6 forming the through hole 8 is pushed toward the outer side, the panel outer side surface 9b is pressed against the panel abutment projection 56. Further, the through hole inner circumference 7 compresses the projection portion 44.

That is, the grommet 100 is mounted on the vehicle body panel 9 with a fitting mechanism formed at three points of the panel abutment projection 56 of the panel abutment portion 50, the inclined portion 42 of the connection portion 40 and the projection portion 44 of the connection portion 40, so that the mounting is reliable and easy, and semi-fitting or the like is prevented. Thus, high water sealing property is achieved.

### (Supplementary Description of Fitting Form in Related Art)

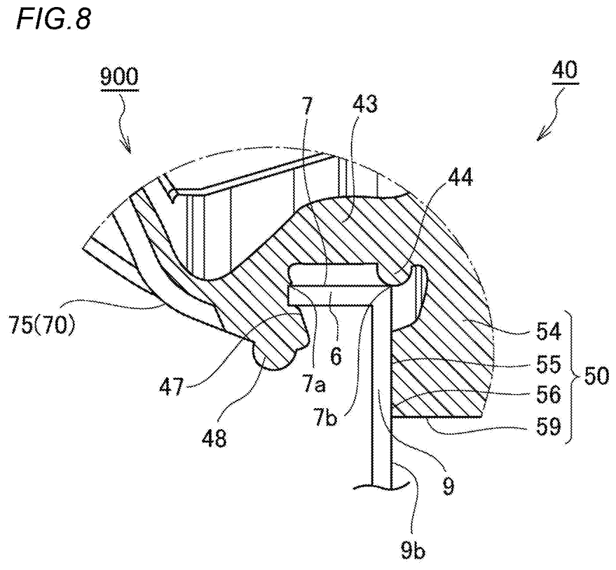

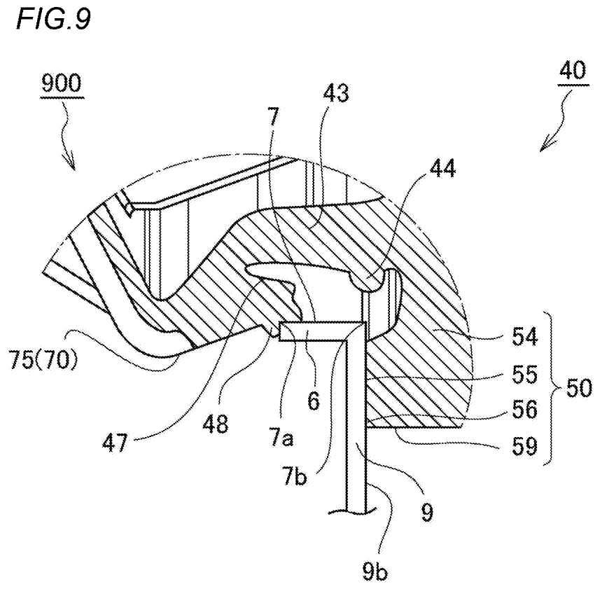

FIGS. 8 and 9 schematically illustrate differences between the fitting form of the grommet according to the first embodiment of the present invention and a fitting form according to the related art, in which FIG. 8 is a cross-sectional view showing a part in a state of being mounted by being pulled toward the inner side in the related art, and FIG. 9 is a cross-sectional view showing a part in a state of being mounted by being pushed from the outer side in the related art. The same or corresponding parts as those in the first embodiment are denoted by the same names and reference numerals, and description thereof will be omitted.

In FIGS. 8 and 9, the connection portion 40 provided in a grommet 900 in the related art includes an overhang portion 47 inclined so as to be slightly toward the outer side outward of the central axis 1, the parallel portion 43 connected to the overhang portion 47, and the projection portion 44 formed in the parallel portion 43. A return-shaped portion 48 projecting outward is formed between the lip mountain 70 and the overhang portion 47.

(When Mounted by being Pulled Toward Inner Side)

In FIG. 8, when the grommet 900 is mounted to the through hole 8 of the vehicle body panel 9 by being pulled toward the inner side, the lip mountain outer surface 75 and the connection portion 40 move toward the inner side while being pulled and reduced in diameter, so that the flange 6 (the same as the through hole inner circumference 7) pushes down the overhang portion 47 in a direction parallel to the parallel portion 43. At this time, although the return-shaped portion 48 is moved rearward, the connection portion 40 (particularly the parallel portion 43) is stretched, so that a distance between the return-shaped portion 48 and the panel abutment projection 56 is longer than a length of the flange 6 (the same as a distance between the through hole front end 7a and the through hole rear end 7b). That is, the flange 6 can drop into the connection portion 40.

Then, when the through hole front end 7a passes over the return-shaped portion 48, the return-shaped portion 48 is elastically restored and increased in diameter, so that the flange 6 apparently enters between the overhang portion 47 and the panel abutment projection 56. As a result, the through hole inner circumference 7 abuts on the projection portion 44. In addition, since the overhang portion 47 is also elastically restored, the through hole front end 7a abuts on the overhang portion 47.

Further, when no pulling force is applied toward the inner side, the connection portion 40 (particularly the parallel portion 43) is contracted, so that the through hole front end 7a bites the overhang portion 47, the through hole inner circumference 7 is pressed against the projection portion 44, and the vehicle body panel 9 is pressed against the panel abutment projection 56, thereby forming a fitting mechanism at three points. At this time, the overhang portion 47 presses the panel outer side surface 9b against the panel abutment projection 56.

(When Mounted by being Pushed from Outer Side)

In FIG. 9, when the grommet 900 is mounted to the through hole 8 of the vehicle body panel 9 by being pushed from the outer side, a compressive force is applied to the connection portion 40 (precisely between the panel abutment surface 55 and a position where the mountain outer surface 75 abuts on the through hole rear end 7b), and the lip mountain outer surface 75 slides on the through hole inner circumference 7. Therefore, the lip mountain outer surface 75 is gradually reduced in diameter, and the overhang portion 47 is pushed down in a direction parallel to the parallel portion 43 (a direction in which an angle formed therebetween is acute).

At this time, since the return-shaped portion 48 is apparently pushed toward the outer side, a distance between the return-shaped portion 48 and the panel abutment projection 56 is shorter than a length of the flange 6 (the same as a distance between the through hole front end 7a and the through hole rear end 7b). That is, the flange 6 cannot fall into the connection portion 40.

Then, when the panel outer side surface 9b abuts on the panel abutment projection 56, the through hole front end 7a remains abutting on the return-shaped portion 48, and the return-shaped portion 48 cannot pass over the through hole front end 7a and slide on the through hole inner circumference 7. That is, apparently, the flange 6 cannot enter between the overhang portion 47 and the panel abutment projection 56. Then, when no pushing force is applied from the outer side and no compressive force is applied on the connection portion 40 (particularly the parallel portion 43), the through hole inner circumference 7 does not abut on the projection portion 44 while the through hole front end 7a bites the overhang portion 47.

Therefore, when the grommet 900 is pushed from the outer side, a fitting mechanism at three points as in a case where the grommet 900 is pulled toward the inner side is not formed, thereby causing a semi-fitting state and low water sealing property. Therefore, the grommet 900 is not suitable for being mounted by being pushed from the rear side.

The present invention has been described above based on the first embodiment. It should be understood by those skilled in the art that the first embodiment is an example, and various modifications can be made to the components and combinations thereof, and such modifications are also within the scope of the present invention.

### INDUSTRIAL APPLICABILITY

Since the present invention has been described above, the present invention can be widely used as various grommets mounted in through holes formed in plate materials in various structures.

What is claimed is:

1. A grommet which is mounted to a through hole formed in a vehicle body panel comprising:
a first harness insertion portion that extends toward a first side of the vehicle body panel and through which a wire harness penetrates;
a second harness insertion portion that extends toward a second side of the vehicle body panel opposite to the first side and through which a wire harness penetrates;
a lip mountain integrated with the first harness insertion portion;
a panel abutment portion that abuts on a periphery of the through hole in a surface of the second side in the vehicle body panel;
a connection portion that connects the lip mountain and the panel abutment portion;
a work unit formed across the second harness insertion portion and the panel abutment portion; and
a work pressing portion integrated with the second harness insertion portion and the work unit,
wherein the connection portion includes:
an inclined portion that is gradually reduced in diameter toward the panel abutment portion;
a parallel portion that is connected to the inclined portion and has a constant outer diameter; and
a projection portion that is formed in the parallel portion and projects outward, and
wherein the lip mountain and the inclined portion are smoothly connected by a mountain-shaped portion having a substantially arc shape in cross section.

2. The grommet according to claim 1,
wherein a flange is formed around the through hole,
wherein when the grommet is mounted to the through hole, the mountain-shaped portion slides on the flange and bends inward, and
wherein in a state that the grommet is mounted in the through hole, the inclined portion and the projection portion are in close contact with the flange.
